(19) United States
(12) Patent Application Publication
(10) Pub. No.: US 2026/0219524 A1
(43) Pub. Date: Jul. 30, 2026

(54) PHOTONIC INTEGRATED CIRCUIT AND METHODS FOR MANUFACTURING AND OPERATING THE SAME

(71) Applicants: Innolume GmbH, Dortmund (DE); SilOriX GmbH, Karlsruhe (DE)

(72) Inventors: Adrian Mertens, Karlsruhe (DE); Carsten Eschenbaum, Karlsruhe (DE); Christian Koos, Siegelsbach (DE); Alexey Kovsh, Dortmund (DE); Alexey Gubenko, Dortmund (DE); Vladislav Bougrov, Dortmund (DE); Aleksei Borodkin, Dortmund (DE)

(21) Appl. No.: 19/040,601

(22) Filed: Jan. 29, 2025

(51) Int. Cl. G02F 1/025

(52) U.S. Cl. CPC G02F 1/025

(57) ABSTRACT

A Photonic Integrated Circuit (PIC), which efficiently combines the functionalities of light emission, coupling and modulation. In the PIC design, light-emitting, modulation and coupling structures are grown such that each of the structures has at least one common underlying non-conductive layer and at least two common SC layers provided on the common underlying non-conductive layer(s). The coupling structure couples light from the light-emitting structure to the modulation structure. The modulation structure comprises one or more optical waveguides (e.g., slot waveguides) each partly implemented in the common SC layers and comprising a waveguide core embedded in a waveguide cladding. The waveguide core comprises at least two waveguide elements spaced apart from each other by an (e.g., organic or inorganic) electro-optic material having a variable refractive index. The waveguide elements are configured to provide electro-optic modulation of the light in response to a drive voltage applied across them.

### TECHNICAL FIELD

The present disclosure relates generally to the field of photonics. In particular, the present disclosure relates to a Photonic Integrated Circuit (PIC) designed to combine the functionalities of light emission, coupling and modulation, as well as to methods for manufacturing and operating such a PIC.

### BACKGROUND

Optoelectronic components for optical communication applications generally provide one functionality, such as a light source (e.g., laser), signal generator (e.g., optical modulator), or signal detector (e.g., photodiode), etc. A Photonic Integrated Circuit (PIC) is the monolithic integration of several functionalities on the same optoelectronic chip, such as a laser integrated with an optical (e.g., electro-absorption) modulator, a semiconductor amplifier integrated with a photodiode, etc. Each functionality must be implemented with a specific material choice and a specific electrical operation mode.

Given the above, one of the main challenges for PICs is the simultaneous optimization of materials and their growing processes for all the required functionalities. For example, how to monolithically integrate passive elements (such as waveguides, optical modulators, etc.) and active elements (such as a laser gain medium, etc.) in such a way that the entire structure is obtained in a single growth process, i.e., without the need for any repeated growth steps, is still under discussion. This will require more layers for the monolithic structure and the use of polymers to increase the efficiency and speed of optical modulation. It should be noted that the fabrication of the existing InP-based lasers requires several (up to 4) re-growth steps to create both laser gain medium and waveguide structures.

Thus, more engineering is required to improve the monolithic integration of various functionalities in PICs.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a PIC design that efficiently combines the functionalities of light emission, coupling (or waveguiding) and modulation.

According to a first aspect, a PIC is provided, which comprises a light-emitting structure, a modulation structure and a coupling structure. The light-emitting structure is configured to emit light, and the modulation structure is configured to modulate the light. The coupling structure is configured to: (i) couple the light emitted by the light-emitting structure to the modulation structure, and (ii) electrically isolate the light-emitting structure from the modulation structure. The PIC is characterized in that the light-emitting structure, the modulation structure and the coupling structure comprise at least one common underlying non-conductive layer and at least two common semiconductor (SC) layers provided on the at least one common underlying non-conductive layer. The PIC is also characterized in that the modulation structure comprises at least one optical waveguide each at least partly implemented in the at least two common SC layers. Each of the at least one optical waveguide comprises a waveguide cladding and a waveguide core embedded in the waveguide cladding. The waveguide core comprises at least two waveguide elements spaced apart from each other by an electro-optic material. The electro-optic material has a variable refractive index and is part of the waveguide cladding. Furthermore, the at least two waveguide elements are configured to provide electro-optic modulation of the light in response to a drive voltage applied across the at least two waveguide elements. This PIC configuration enables efficient monolithic integration of light emission, coupling and modulation functionalities on the same substrate or chip. In other words, due to the common underlying and SC layers, the light-emitting structure, the modulation structure and the coupling structure may be fabricated simultaneously in a single PIC manufacturing cycle.

In one exemplary embodiment of the first aspect, the electro-optic material is an organic or inorganic material. Organic or inorganic electro-optic materials may provide more efficient electro-optic modulation.

In one exemplary embodiment of the first aspect, each of the at least one optical waveguide is implemented as one of a slot waveguide, a sub-wavelength grating structure and a photonic-crystal waveguide. These types of optical waveguides may provide efficient electro-optic modulation.

In one exemplary embodiment of the first aspect, the at least two common SC layers comprise a first SC layer provided on the at least one common underlying non-conductive layer and at least two second SC layers provided on the first SC layer. In this embodiment, the first SC layer is part of the waveguide cladding and the at least two waveguide elements are implemented in the at least two second SC layers. Furthermore, the first SC layer is oxidized under the at least two waveguide elements so as to provide electrical isolation of the at least two waveguide elements from each other. Said oxidation may lead to the reduction of the refractive index, which helps to confine an optical wave within the spacing between the waveguide elements. In other words, the oxidized region of the first SC layer works as a bottom cladding within the modulation structure.

In one exemplary embodiment of the first aspect, the light-emitting structure is implemented as a single-mode laser. Unlike multi-mode lasers (e.g., comb lasers), single-mode lasers have a simple structure, strong stability, and high reliability.

In one exemplary embodiment of the first aspect, the single-mode laser comprises a Fabry-Perot (FP) cavity or a Distributed Feedback (DFB) cavity. FP-based lasers have a generally wide spectral width and is mostly used for low-rate short-distance transmission, while DFB-based lasers have a generally narrow spectral width and is mostly used for high-rate medium/long-distance transmission. It should be also noted that the DFB-based lasers tend to be much more stable than the FP-based lasers and are used frequently when clean single-mode operation is needed. Thus, depending on which of these types of cavities is used, the PIC may be used either in low-rate short-distance optical communications or in high-rate medium/long-distance optical communications, which makes the PIC more flexible in use.

In one exemplary embodiment of the first aspect, the single-mode laser comprises a Distributed Bragg Reflector (DBR). Depending on its implementation, the DBR may be used as a wavelength filter, a polarization splitter, and/or a high-reflection mirror in the PIC, thereby providing the monolithic integration of one or more additional functionalities in the PIC. Furthermore, the DBR may provide the ability to deliver high output light power into the coupling structure of the PIC.

In one exemplary embodiment of the first aspect, the light-emitting structure comprises: a bottom cladding layer having a first electrical conductivity, a core layer provided on the bottom cladding layer and made of a light-emitting SC material, and a top cladding layer provided on the core layer and having a second electrical conductivity. The second electrical conductivity is opposite to the first electrical conductivity. In this embodiment, the core layer has a refractive index higher than a refractive index of each of the bottom cladding layer and the top cladding layer, and the bottom cladding layer is provided on the at least two common SC layers. The light-emitting structure thus configured may generate and focus the light on the coupling structure more efficiently.

In one exemplary embodiment of the first aspect, the core layer comprises at least one of: a sub-layer of quantum dots (e.g., based on a GaAs-based material platform), a sub-layer of quantum wells, a sub-layer of quantum dashes, and a sub-layer of quantum wires. The light-emitting structure having a core layer based on one or more of such low-dimensional systems may demonstrate better performance in terms of a gain, a threshold current and a modulation bandwidth.

In one exemplary embodiment of the first aspect, each of the at least one optical waveguide is implemented as the slot waveguide, and the at least two waveguide elements are configured as two conductive rails of the slot waveguide. In this embodiment, the two rails of the slot waveguide have an inter-rail spacing of less than 500 nm, preferably less than 200 nm. The slot waveguide with such a narrow slot may cause the drive voltage across the rails to drop completely across the slot, thereby leading to a strong electric field which is well confined to the slot region.

In one exemplary embodiment of the first aspect, the electro-optic material has an electro-optic coefficient r33 of more than 50 pm/V. By using such electro-optic materials, it is possible to provide desired electro-optic modulation of the light more efficiently.

In one exemplary embodiment of the first aspect, the coupling structure is shaped to taper towards the modulation structure. The tapered coupling structure may couple the light from the light-emitting structure to the modulation structure more efficiently (e.g., in terms of optical losses). More specifically, the tapered coupling structure may facilitate evanescent adiabatic coupling between the two structures.

In one exemplary embodiment of the first aspect, the coupling structure is shaped to taper faster first and then slower towards the modulation structure. This differently tapered coupling structure may be beneficial for the following two reasons: said fast tapering may allow one to reduce the width of the whole PIC structure relatively fast, while said slow tapering may minimize optical losses. Furthermore, said fast tapering is also needed to save some space on the substrate or chip, since light coupling only by means of said slow tapering would lead to a relatively long PIC structure.

In one exemplary embodiment of the first aspect, the coupling structure comprises at least one of a grating and an evanescent coupling element. By using the grating and/or evanescent coupling element, it is possible to improve the electrical isolation between the light-emitting structure and the modulation structure.

In one exemplary embodiment of the first aspect, the PIC further comprises an inert encapsulation layer covering the electro-optic material. The inert layer may provide protection of the electro-optical material from oxygen indiffusion.

According to a second aspect, a method for manufacturing the PIC according to the first aspect is provided. The method starts with the step of providing the at least one common underlying non-conductive layer. Then, the method proceeds to the step of epitaxially growing a stack of SC layers on the at least one common underlying non-conductive layer. The stack of SC layers comprises the at least two common SC layers. Next, the method goes on to the step of treating the stack of SC layers within the modulation structure so as to access the at least two common SC layers. After that, the method proceeds to the step of forming each of the at least one optical waveguide at least partly in the at least two common SC layers such that the at least two waveguide elements of the waveguide core are spaced apart from each other. Further, the method goes on to the step of depositing the electro-optic material on and between the at least two waveguide elements. In doing so, it is possible to provide the monolithic integration of light emission, coupling and modulation functionalities on the same substrate or chip. In other words, due to the common underlying and SC layers, the light-emitting structure, the modulation structure and the coupling structure may be fabricated simultaneously in a single PIC manufacturing cycle.

In one exemplary embodiment of the second aspect, the method further comprises the step of applying a poling voltage to the electro-optic material after its deposition. The application of the poling voltage (optionally, together with some heat treatment) may lead to at least partly “acentric alignment” of the electro-optic material while the modulation structure is manufactured. That is, the molecules of the electro-optic material may be generally oriented across the spacing between the waveguide elements of each optical waveguide, and the electric field resulted from applying the drive voltage across the waveguide elements of the optical waveguide during the PIC operation may be oriented parallel (anti-parallel) with respect to the orientation of the molecules in the spacing and cause a controllable phase shift in the light coupled in the modulation structure. If the electro-optic material is a polymer material, then the application of the poling voltage may provide at least partly acentric alignment of electro-optic chromophores in a pure material or polymer matrix.

According to a third aspect, a method for operating the PIC according to the first aspect is provided. The method starts with the step of causing the light-emitting structure to emit the light by applying a bias signal to the light-emitting structure. Then, the method proceeds to the step of coupling the light emitted by the light-emitting structure to the modulation structure via the coupling structure. After that, the method goes on to the step of modulating the light in the modulation structure by applying the drive voltage across the at least two waveguide elements of each of the at least one optical waveguide. In doing so, it is possible to provide light modulation in the PIC according to the first aspect.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIGS. 1A-1D show different schematic views of a Photonic Integrated Circuit (PIC) according to one exemplary embodiment, namely: FIG. 1A shows a top view of the PIC;

FIG. 1B shows a sectional side view of a light-emitting structure included in the PIC, as obtained by using section line A-A′ in FIG. 1A; FIG. 1C shows a sectional side view of a coupling structure included in the PIC, as obtained by using section line B-B′ in FIG. 1A; and

FIG. 1D shows a sectional side view of a modulation structure included the PIC, as obtained by using section line C-C′ in FIG. 1A;

FIG. 2 schematically explains how to provide the electrical isolation between the light-emitting and modulation structures of the PIC according to one other exemplary embodiment;

FIGS. 3A and 3B schematically explains how to provide the electrical isolation between the light-emitting and modulation structures of the PIC according to one other exemplary embodiment;

FIG. 4 schematically explains how to provide the electrical isolation between the light-emitting and modulation structures of the PIC according to one other exemplary embodiment;

FIGS. 5A and 5B show schematic top and side views of one other modulation structure with two slot waveguides, which may be used in the PIC;

FIG. 6 shows a flowchart of a method for manufacturing the PIC according to one exemplary embodiment;

FIGS. 7A-7D schematically illustrate how the modulation structure of the PIC may be manufactured in accordance with the method of FIG. 6; and

FIG. 8 shows a flowchart of a method for operating the PIC according to one exemplary embodiment.

### DETAILED DESCRIPTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and methods disclosed herein may be implemented in practice by using any numbers of the embodiments provided herein.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above” “below”, “upper”, “lower”, “horizontal”, “vertical”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. As an example, if one imaginatively rotates the apparatus in the figures 90 degrees clockwise, elements or features described as “left” and “right” relative to other elements or features would then be oriented, respectively, “above” and “below” the other elements or features. Therefore, the positioning terminology used herein should not be construed as any limitation of the present disclosure.

Furthermore, although the numerative terminology, such as “first”, “second”, etc., may be used herein to describe various embodiments, elements or features, it should be understood that these embodiments, elements or features should not be limited by this numerative terminology. This numerative terminology is used herein only to distinguish one embodiment, element or feature from another embodiment, element or feature. For example, a first semiconductor (SC) layer discussed herein could be called a second SC layer, and vice versa, without departing from the teachings of the present disclosure.

As used in the embodiments disclosed herein, a PIC may refer to a chip (or substrate or wafer) comprising photonic components that are configured to operate with photons. Light may be injected into or generated in the PIC to drive the photonic components. The photonic components of the PIC may include those configured to provide optical passive waveguiding, polarization, optical amplification, signal generation (amplitude or phase modulation), photodetection, etc. Each of the photonic components may be implemented as a multi-layered structure on the chip, which may comprise different conductive, non-conductive and/or SC layers.

According to the embodiments disclosed herein, a layer may refer to a sheet of substance on top of a substrate (or wafer or chip) or another layer. When multiple layers are arranged on top of each other, they form a stack of layers. It should be noted that some layers discussed herein may have one or more openings or cuts to provide access to one or more underlying layers and/or to form a certain structure (like a waveguiding structure, for example).

As used in the embodiments disclosed herein, an electro-optic material may refer to a material whose optical properties, in particular the real part and/or the imaginary part of the complex-valued refractive index, are changed in case of an externally applied voltage and/or a current flow associated with such voltage. This comprises, e.g., substances that exhibit a linear electro-optic effect (Pockels effect) or a quadratic electro-optic effect (electro-optic Kerr effect). An organic electro-optic material is an electro-optic material for which the electro-optic activity relies at least partly on a molecular moiety that comprises least 6 carbon atoms covalently bound to one another.

According to the embodiments disclosed herein, an optical waveguide may refer to a structure comprising at least one waveguide core (i.e., a region which interacts with guided light and whose refractive index is greater than that of a guided mode) and at least one waveguide cladding (i.e., a region which interacts with the guided light and whose refractive index is less than that of the guided mode).

The waveguide core may be configured as a single-or multi-part waveguide structure in combination with a cladding of partially nonlinear electro-optical, partially linear electro-optical materials having a high electrical refractive index. For a high modulation efficiency, the most possible interaction of an optical field with an electrical modulation field is required. This interaction in the electro-optical material is increased by an elevation of the optical field and the electrical modulation field. To this end, the continuity condition for the normal component of a dielectric displacement density at dielectric interfaces is utilized. If the optical waveguide is represented by a slot waveguide, the waveguide core is a multi-part structure which comprises at least two waveguide core stripes (or conductive rails).

The waveguide core may also be formed by periodic or non-periodic structures having structural details much smaller than an optical wavelength, for example, with a waveguide core consisting of blocks of materials of high refractive index arranged in an unconnected manner along the direction of light propagation (i.e., the so-called “sub-wavelength grating waveguides”). These structures may be embodied both as strip waveguides and as slot waveguides and enable a stronger interaction of an optical wave with the electro-optical cladding material. Furthermore, the waveguide core or surrounding regions along the propagation direction may be structured such that the propagation properties of the optical mode are advantageously influenced. These include, for example, the so-called “slow light structures” which reduce the group velocity of the guided light and thus increase the interaction time of the optical field with the electro-optical material. This leads to a high electro-optical interaction on a short path. Slow light structures may be realized, for example, by photonic crystals. Structures may also be implemented, which adapt the group velocity of the optical field to that of an electrical modulation wave.

A variety of materials having low optical losses and a sufficiently high refractive index may be considered as the core material. These are, for example, semiconductors, such as Si, Ge, GaAs, InP or other related compound semiconductors, or compounds such as silicon nitride (Si₃N₄ or SiNₓ), silicon oxynitride (SiNₓO_{y}) or related ceramics. Furthermore, titanium oxide (TiO₂ or TiOₓ), silicon dioxide (SiO₂) or other oxides, or even organic compounds or polymers may be used. In the case of semiconductors, all these core materials may be present in doped or undoped form. Additions, such as germanium or phosphorus, may also be used as dopants to change the optical and electrical properties of the waveguide core. The optical refractive index of the waveguide core material is preferably above 2.1, more preferably above 2.8, and most preferably above 3.7.

By embedding the waveguide core in a suitably selected cladding material, efficient light guidance may be achieved in the waveguide core. These cladding materials are electro-optic materials, such as organic electro-optic materials, organic electro-optic dyes or electro-optical polymers. The optical refractive index of the electro-optical material is preferably less than 2.4, more preferably less than 2 and most preferably less than 1.8.

The exemplary embodiments disclosed herein relate to a PIC design that efficiently combines the functionalities of light emission, coupling (or waveguiding) and modulation. To achieve this, a light-emitting structure, a modulation structure and a coupling structure are jointly grown such that each of the structures has at least one common underlying non-conductive layer (e.g., in the form of a substrate or wafer) and at least two common SC layers provided on the at least one common underlying non-conductive layer. The coupling structure is configured to couple light from the light-emitting structure to the modulation structure and electrically isolate them from each other. In this PCI design, the modulation structure comprises one or more optical waveguide each at least partly implemented in the at least two common SC layers. Each optical waveguide comprises a waveguide cladding and a waveguide core embedded in the waveguide cladding. The waveguide core comprises at least two waveguide elements spaced apart from each other by an organic electro-optic material having a variable refractive index being part of the waveguide cladding. The at least two waveguide elements are configured to provide electro-optic modulation of the light in response to a drive voltage applied across them. Said electro-optic modulation may refer to a process of changing an optical signal or light in amplitude and/or phase through an electrical signal (e.g., voltage).

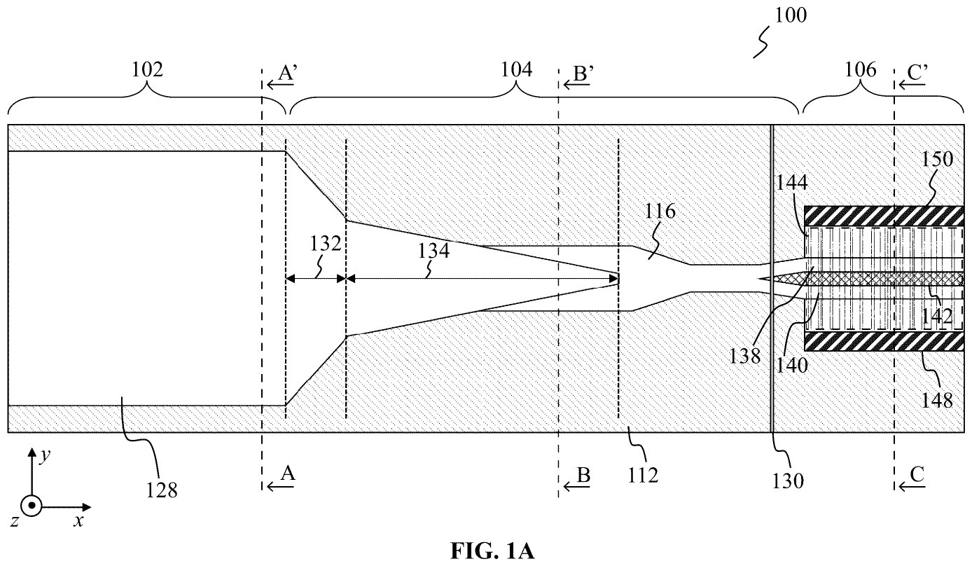

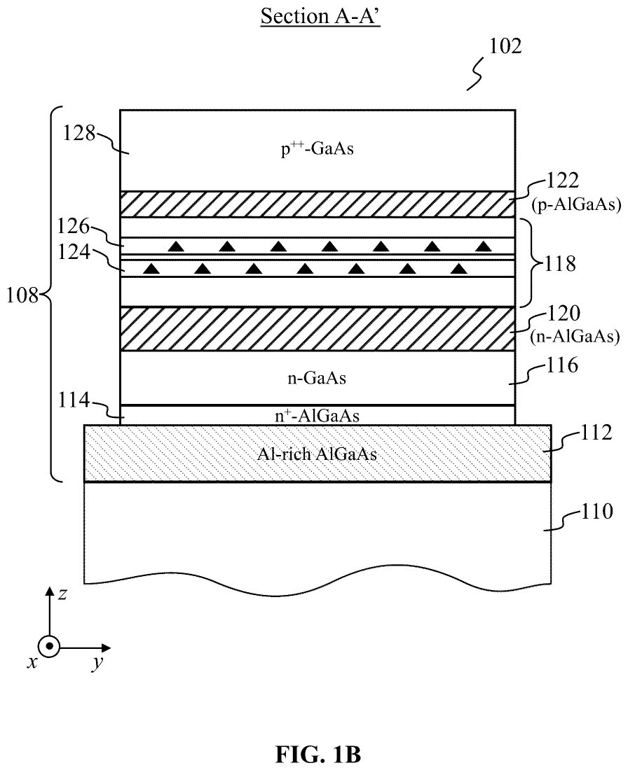

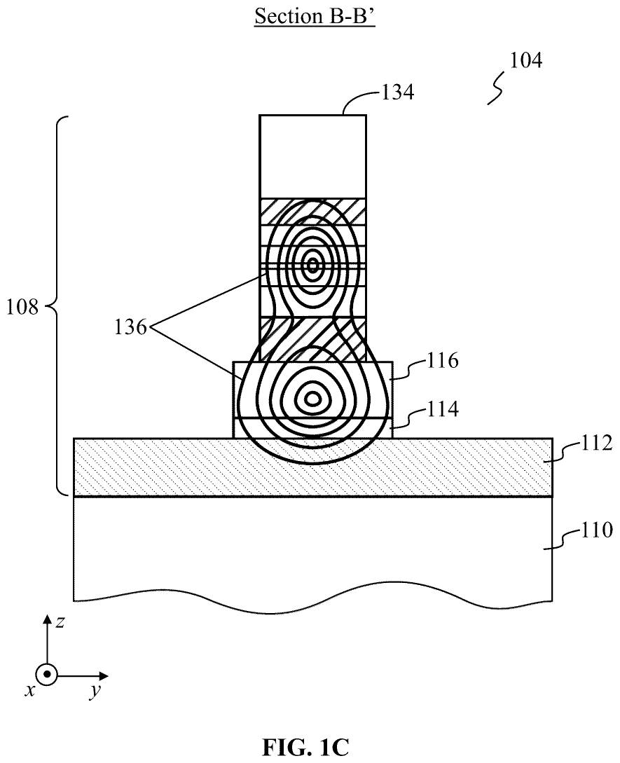

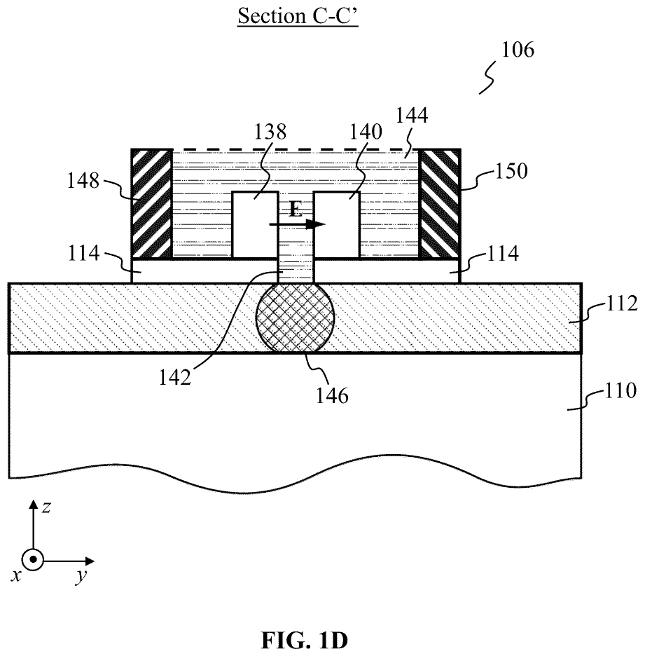

FIGS. 1A-1D show different schematic views of a PIC 100 according to one exemplary embodiment. The PIC 100 comprises a light-emitting structure 102, a coupling structure 104, and a modulation structure 106. FIG. 1A shows a top view of the whole PIC 100, i.e., each of the light-emitting structure 102, the coupling structure 104 and the modulation structure 106. FIG. 1B shows a sectional side view of the light-emitting structure 102, as obtained by using section line A-A′ in FIG. 1A. FIG. 1C shows a sectional side view of the coupling structure 104, as obtained by using section line B-B′ in FIG. 1A. FIG. 1D shows a sectional side view of the modulation structure 106, as obtained by using section line C-C′ in FIG. 1A. Each of the light-emitting structure 102, the coupling structure 104 and the modulation structure 106 will be described below in more detail.

As shown in FIG. 1B, the light-emitting structure 102 is implemented as an AlGaAs/GaAs heterostructure 108 epitaxially grown on an underlying non-conductive layer (or substrate) 110. The non-conductive layer 110 may be made of silicon dioxide, silicon nitride (Si₃N₄), silicon oxiditride (SiNₓO_{y}) or related materials, aluminum oxide (Al₂O₃) or related materials. In general, the choice of a material for the non-conductive layer 110 depends on a type of the heterostructure 108 to be grown thereon; in this case, the conductive layer 110 may be made of GaAs, for example. The heterostructure 108 comprises three SC layers 112, 114 and 116 which are common to each of the light-emitting structure 102, the coupling structure 104 and the modulation structure 106. In other words, the SC layers 112, 114 and 116 extend throughout the PIC 100 along an x-axis. The SC layer 112 is made of Al-rich AlGaAs and provided on the non-conductive layer 110. The SC layer 114 is made of n⁺-AlGaAs and provided on the SC layer 112. The SC layer 116 is made of n-GaAs and provided on the SC layer 114. The heterostructure 108 further comprises a core layer 118 made of a light-emitting SC material and sandwiched between a bottom cladding layer 120 and a top cladding layer 122. The bottom cladding layer 120 is made of n-AlGaAs and provided on the SC layer 116, while the top cladding layer 122 is made of p-AlGaAs and provided on the core layer 118. In other words, the bottom and top cladding layers 120 and 112 have opposite electrical conductivities. The core layer 118 includes two (or more) sub-layers 124 and 126, each of which is assumed to comprise an array of (In,Ga)As quantum dots (which are schematically shown as black triangles in FIG. 1B); the quantum dots may be also made of InAs and embedded into layers of quantum wells (InGaAs), and some intermediate layers of GaAs may be used as well. The exact concentration of the materials for the quantum dots may differ depending on required device characteristics (e.g., a range of operational wavelengths). The core layer 118 should have a refractive index higher than that of each of the bottom and top cladding layers 120 and 122, so that light emitted by the quantum dots is directed within the core layer 118 to the coupling structure 104 along the x-axis. There is also a top contacting layer 128 in the heterostructure 108, which is made of p⁺⁺-GaAs and provided on the top cladding layer 122.

It should be noted that the AlGaAs/GaAs heterostructure 108 shown in FIG. 1B is only one non-restrictive example of a semiconductor laser which may be used as the light-emitting structure 102 in the PIC 100. In some embodiments, the number of common SC layers may be two or more than three—for example, a greater amount of common SC layers may be used when it is required to compensate the material lattice mismatch between the non-conductive layer 110 and the heterostructure 108 (in this case, the common SC layers may also serve as buffer layers), and/or some more common layers may be needed to achieve move effective modulation as well (e.g., for the modulation structure 106, waveguide elements may contain, and will actually, slightly differently doped materials). Furthermore, the number of the sub-layers included in the core layer 118 may be also more than two, or there may be a single sub-layer with an array of quantum dots in the core layer 118. Other embodiments are possible, in which the core layer 118 comprises, instead the arrays of quantum dots, other low-dimensional systems, such as quantum wells, quantum dashes, quantum wires, or any combination thereof. Moreover, instead of the AlGaAs and GaAs, the light-emitting structure 102 may be based on any other SC materials having similar lattice parameters, such as Si and Ge (e.g., Si/SiGe heterostructures are known, which may also operate as laser structures).

In general, the light-emitting structure 102 may be implemented as a single-mode laser. Optionally, such a single-mode laser may comprise a Fabry-Perot (FP) cavity or a Distributed Feedback (DFB) cavity, as well as may comprise a Distributed Bragg reflector.

The light-emitting structure 102 may be also implemented differently. For example, instead of a SC laser, it may be implemented as a Light Emitting Diode (LED) in the PIC 100.

The coupling structure 104 is configured to couple the light emitted by the light-emitting structure 102 (i.e., the arrays of quantum dots in the core layer 118) to the modulation structure 106, as well as to provide electric isolation between the light-emitting structure 102 and the modulation structure 106. As can be seen from FIG. 1A, the coupling structure 104 comprises a groove 130 which is etched along a z-axis down to the non-conductive layer 110 and has a width (along the x-axis) smaller than the wavelength of the light. In this case, the light “treats” the whole PIC structure as a single waveguide, while the groove 130 provides the electrical isolation between the light-emitting structure 102 and the modulation structure 106. In other words, one can say that the coupling structure 104 is physically connected to the light-emitting structure 102 (i.e., its core layer 118) and optically (via the properly sized groove 130) connected to the modulation structure 106.

As follows from FIGS. 1A and 1C, the coupling structure 104 is also implemented based on the heterostructure 108 provided on the non-conductive layer 110. However, within the coupling structure 104, the heterostructure 108 is shaped to taper towards the modulation structure 106. More specifically, the coupling structure 104 comprises two differently tapered parts 132 and 134, with the (left) part 132 being shaped to taper faster than the (right) part 134. Moreover, the heterostructure 108 is etched to the SC layer 116 in vicinity of the end of the tapered part 134. FIG. 1C schematically shows the transition of an optical mode 136 (of the light emitted) from the core layer 118 of the light-emitting structure 102 to the (waveguiding) SC layers 114 and 116 of the heterostructure 108.

The tapered configuration of the coupling structure 104, which is shown in FIGS. 1A and 1C, should not be construed as any limitation of the present disclosure. In some other embodiments, instead of comprising the two differently tapered parts 132 and 134, the coupling structure 104 may gradually and equally taper towards the modulation structure 106. Furthermore, in addition to or as an alternative to the differently tapered parts 132 and 134, the coupling structure may comprise a grating and/or an evanescent coupling element. On top of that, the coupling structure 104 should not be necessarily made of the same heterostructure as the one used in the light-emitting structure 102 - instead, the coupling structure 104 may be made of a different layered SC (hetero)structure or any other materials that exhibit waveguide properties (e.g., optical glass, silica glass, oxide glasses, etc.).

The modulation structure 106 is configured to receive the light (i.e., the optical mode 136) from the light-emitting structure 102 via the coupling structure 104 and perform desired electro-optic (i.e., amplitude and/or phase) modulation thereon. As shown in FIGS. 1A and 1D, the modulation structure 106 comprises a slot waveguide comprising two conductive rails 138 and 140 implemented in the SC layer 116 with a slot 142 therebetween. In other words, the SC layer 116 terminates in two spaced-apart longitudinal strips within the modulation structure 106, which serve as the rails 138 and 140 of the slot waveguide. The slot 142 goes also through the SC layer 114 to the SC layer 112 and is covered with an organic electro-optic material 144 having a variable refractive index. The slot 142 may be less than 500 nm, preferably between 50 nm and 500 nm, more preferably between 80 nm and 300 nm, and most preferably between 100 nm and 200 nm. The refractive index of the organic electro-optic material 144 may range from 1.4 to 2.1. Furthermore, the organic electro-optic material 144 may be selected based on the condition that its electro-optic coefficient r33 of more than 50 pm/V, more preferably more than 100 pm/V, and most preferably more than 200 pm/V. Some examples of suitable organic electro-optic material 144 may include, but are not limited to, a functionalised polymer, for example a “guest-host” polymer or a “cross-linked” polymer, an organic crystal, for example DAST (4-N, N-dimethyl amino-4′-N′-methyl-stilbazolium tosylate, or DAT2 (2-{3-[2-(4-dimethyl amino phenyl)vinyl]-5,5-dimethyl cyclohex-2-enylidene}malononitrile), or an organic salt, for example DSTMS (4-N, N-dimethyl amino-4′-N′-methyl-stilbazolium 2,4,6-trimethyl benzene sulfonate), or DSNS (4-N, N-dimethyl amino-4′-N′-methyl-stilbazolium 2-naphtalene sulfonate). As the case may be, these materials have to be poled by applying a voltage. Furthermore, electro-optical interactions may be achieved in materials only having a non-linear effect of third order (quadratic electro-optical effect), for example glasses (chalco genide glasses). These materials may be poled by applying a voltage.

As shown in FIG. 1D, the SC layer 112 is oxidized in a region 146 under the slot 142 such that the rails 138 and 140 are electrically isolated from each other. The modulation structure 106 may optionally comprise electrodes 148 and 150 formed on the underlying SC layer 114 on the outer sides of the rails 138 and 140. The electrodes 148 and 150 may be used to apply a poling voltage to the organic electro-optic material 144, as will be discussed later in more detail.

It should be noted that the present disclosure is not limited to the modulation structure 106 shown in the figures and described above. In some other embodiments, the modulation structure 106 may comprise, instead of the slot waveguide, any other type of optical waveguides capable of providing desired electro-optic modulation. For example, the slot waveguide may be replaced with a sub-wavelength grating structure or a photonic-crystal waveguide that are well-known in the art, for which reason their description is omitted herein.

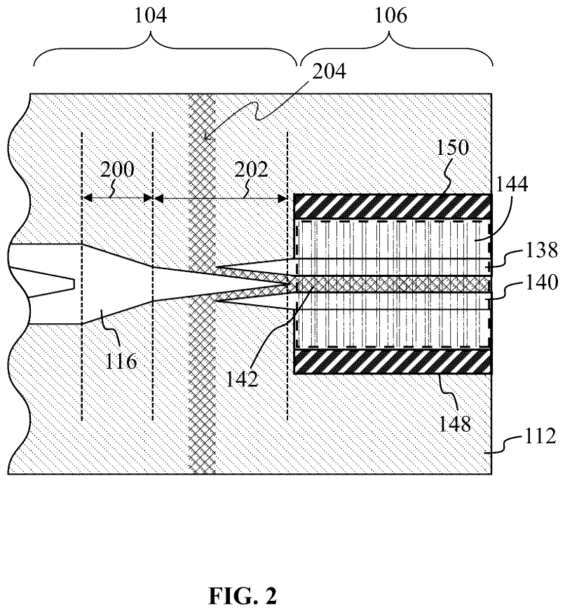

FIG. 2 schematically explains how to provide the electrical isolation between the light-emitting and modulation structures 102 and 106 of the PIC 100 according to one other exemplary embodiment. In this embodiment, the electrical isolation is provided by making the SC layers 114 (not shown) and 116 tapered towards the modulation structure 106 and additionally oxidizing the SC layer 112 under the tapered SC layers 114 and 116. More specifically, there may be two differently tapered parts 200 and 202 implemented in the SC layers 114 and 116, with the part 200 being shaped to taper faster than the part 202. Said oxidization may be performed along a thin strip 204 extending under the slow-tapered part 202.

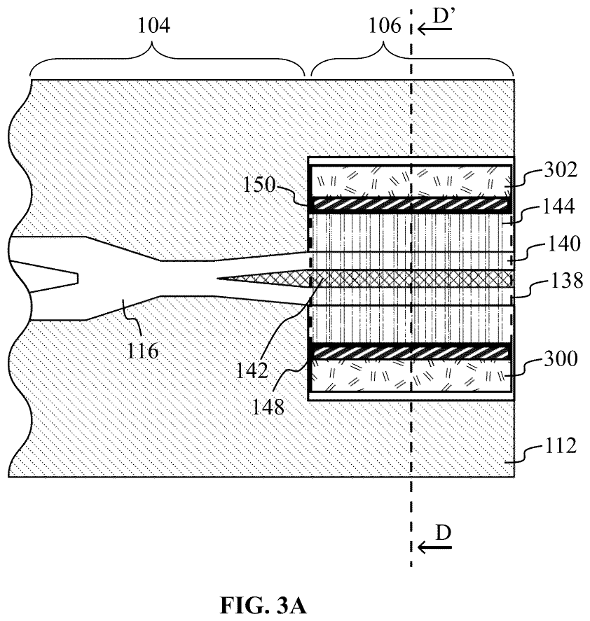

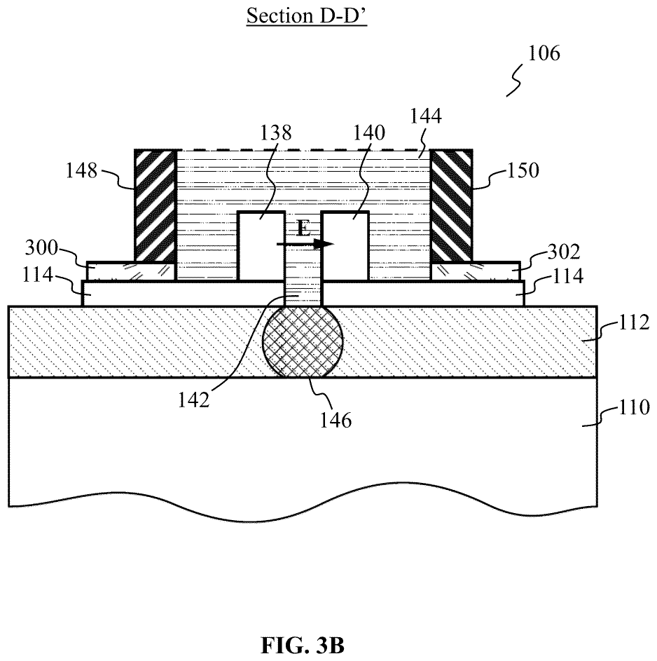

FIGS. 3A and 3B schematically explains how to provide the electrical isolation between the light-emitting and modulation structures 102 and 106 of the PIC 100 according to one other exemplary embodiment. In this embodiment, the electrical isolation is provided by forming the electrodes 148 and 150 on dielectric layers 300 and 302, respectively, which are deposited on the SC layer 114.

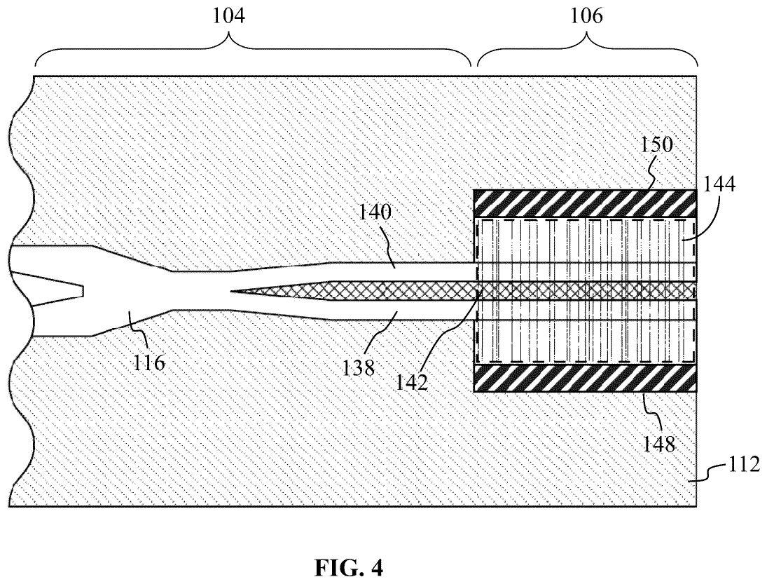

FIG. 4 schematically explains how to provide the electrical isolation between the light-emitting and modulation structures 102 and 106 of the PIC 100 according to one more other exemplary embodiment. In this embodiment, the electrical isolation is provided by elongating the slot 142 such that it extends farther within the coupling structure 104. In this case, the SC layer 112 is oxidized along the entire slot 142 (i.e., not only within the modulation structure 106). The combination of the elongated slot 142 and the relatively narrow widths of the SC layers may result in high resistance.

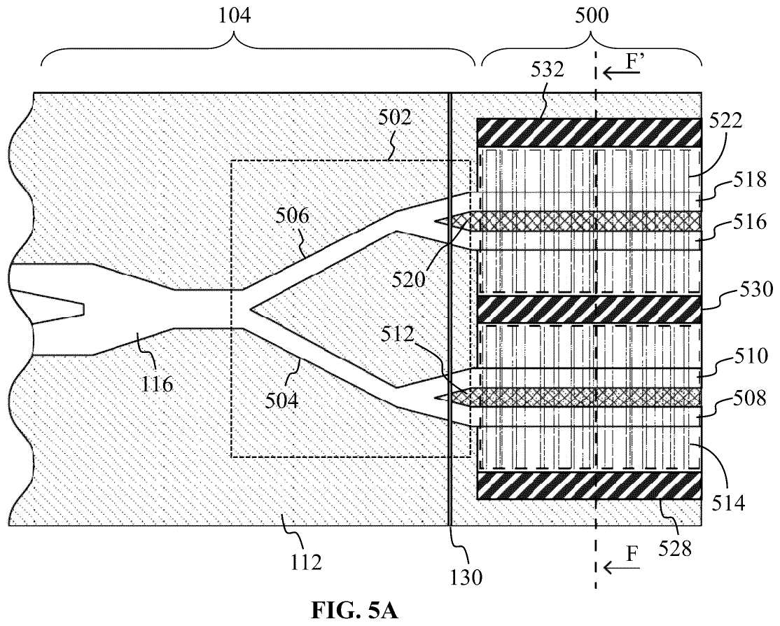

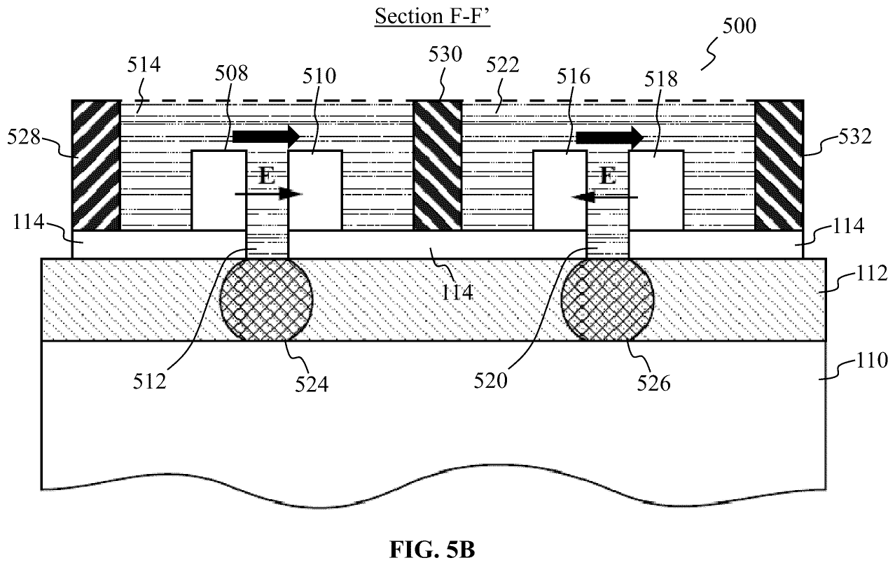

FIGS. 5A and 5B show schematic top and side views of a different modulation structure 500 with two slot waveguides, which may be used in the PIC 100 (instead of the modulation structure 106). More specifically, FIG. 5A shows a top view of the modulation structure 500, while FIG. 1B shows a sectional side view of the modulation structure 500, as obtained by using section line F-F′ in FIG. 5A.

For the modulation structure 500 to be integrated in the PIC 100, the coupling structure 104 should additionally comprise a splitting part 502 which is provided right before the modulation structure 500 and electrically isolated therefrom, for example, by means of the groove 130. The splitting part 502 comprises a bottom branch 504 and a top branch 506 which are again implemented in the SC layer 116. In other words, the SC layer 116 terminates in two diverging longitudinal strips within the coupling structure 104, which may perform a splitting function. It should be noted that the branches 504 and 506 may be configured to perform wavelength-based splitting of the light propagating via the coupling structure 104 towards the modulation structure 500.

Each of the two light beams resulted from splitting the light by means of the branches 504 and 506 is further directed to one of the two slot waveguides. Each of the two slot waveguides may be implemented in the same or similar manner as the slot waveguide shown in FIG. 1C. With reference to FIG. 5A, the bottom slot waveguide comprises two conductive rails 508 and 510 implemented in the SC layer 116 with a slot 512 therebetween. In other words, the branch 504 terminates in two spaced-apart longitudinal strips within the modulation structure 500, which serve as the rails 508 and 510 of the bottom slot waveguide. The slot 512 is filled with an organic electro-optic material 514. The top slot waveguide comprises two conductive rails 516 and 518 implemented in the SC layer 116 with a slot 520 therebetween. In other words, the branch 506 terminates in two spaced-apart longitudinal strips within the modulation structure 500, which serve as the rails 516 and 518 of the top slot waveguide. Each of the slots 512 and 520 goes also through the SC layer 114 to the SC layer 112, and the SC layer 114 is oxidized in regions 524 and 526 under the slots 512 and 520, respectively.

It should be noted that each of the bottom and top slot waveguides shown in FIGS. 5A and 5B may be configured differently to provide different electro-optic modulation for each of the two light beams. For example, the slots 512 and 520 may be differently sized, and/or the organic electro-optic materials 514 and 522 may be different (i.e., with different variable refractive indices), and/or the sizes of the rails 508 and 510 may differ from those of the rails 516 and 518.

As also shown in FIGS. 5A and 5B, the modulation structure 500 may optionally comprise electrodes 528, 530 and 532, which may serve the same purpose as the electrodes 148 and 150. In other words, the electrodes 528 and 530 may be used to apply a poling voltage to the molecules of the organic electro-optic material 514, while the electrodes 530 and 532 may be used to apply a poling voltage to the molecules of the organic electro-optic material 522. If the organic electro-optic materials 514 and 522 are the same, their exposure to the poling voltage will result in aligning the molecules therein in the same direction (see thick black arrows in FIG. 5B). After said poling, applying a drive voltage to each of the two slot waveguides will lead to modulating electrical fields E oriented in opposite directions with respect to the alignment of the molecules in the slots 512 and 520, thereby providing phase shifts of equal magnitudes but opposite signs in the slots 512 and 520. All of this may lead to chirp-free amplitude modulation. It should be noted that FIGS. 5A and 5B show one of possible drive configurations of the electrodes 528, 530 and 532; in some other embodiments, they may also be in a differential drive configuration, for example.

Those skilled in the art would recognize that the present disclosure is not limited to the number of the slot waveguides shown in FIGS. 5A and 5B. In some other embodiments, the number of slot waveguides used in the PIC 100 may vary depending on how many light beams are required to obtain and modulate within the PIC 100. Similarly, instead of two or more slot waveguides, the modulation structure 106 may comprises two or more other optical waveguides, such as sub-wavelength grating structures or photonic-crystal waveguides.

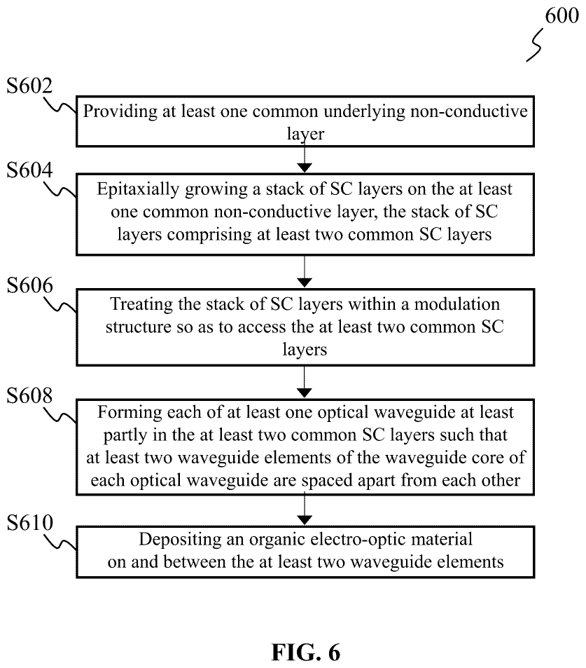

FIG. 6 shows a flowchart of a method 600 for manufacturing the PIC 100 according to one exemplary embodiment. The method 600 starts with a step S602, in which the non-conductive layer 110 is provided, e.g., in the form of a single-or multi-layered substrate. Then, the method 600 goes on to a step S604, in which a stack of SC layers is epitaxially grown on the non-conductive layer 110. The stack of SC layers comprises the common SC layers 112-116. Next, the method 600 proceeds to a step S606, in which the stack of SC layers is treated (e.g., by means of the conventional etching and/or lithography techniques) within the modulation structure 106 such that the SC layer 116 is exposed. After that, the method 600 proceeds to a step S608, in which the optical waveguide in the form of the slot waveguide is formed, with the slot waveguide comprising the waveguide core in the form of the conductive rails 138 and 140 in the (exposed) underlying SC layer 116 with the slot 142 therebetween. Further, the method 600 goes on to a step S610, in which the organic electro-optic material is deposited on and between the conductive rails 138 and 140.

It should be noted that, since the optical waveguide is implemented as the slot waveguide, it can be additionally required, in the step S608 to oxidize the region 146 of the SC layer 112 under the slot 142 to provide proper electrical isolation of the rails 138 and 140 from each other.

In one embodiment, the method 600 may further comprise, after the step S612, additional steps, in which the electro-optic material 144 is optionally heated to its glass transition point and a poling voltage is then applied thereto. The poling voltage may be applied externally or by means of the electrodes 148 and 150.

It should be noted that the modulation structure 500 may be manufactured in a similar manner. To do this, one needs to form the splitting part 502 in the coupling structure 104 in the step S606, as well as to form the two slot waveguides shown in FIGS. 5A and 5B in the step S608.

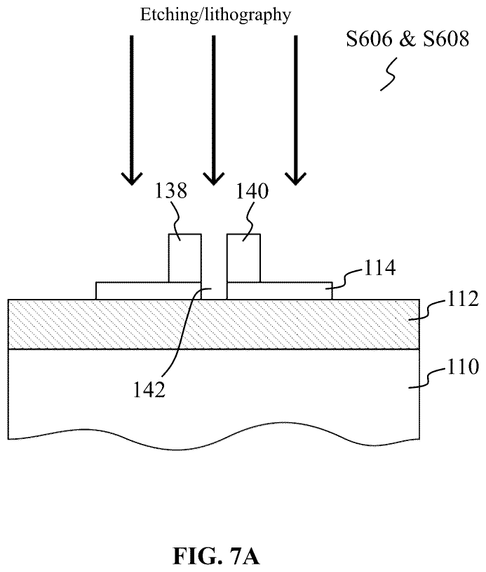

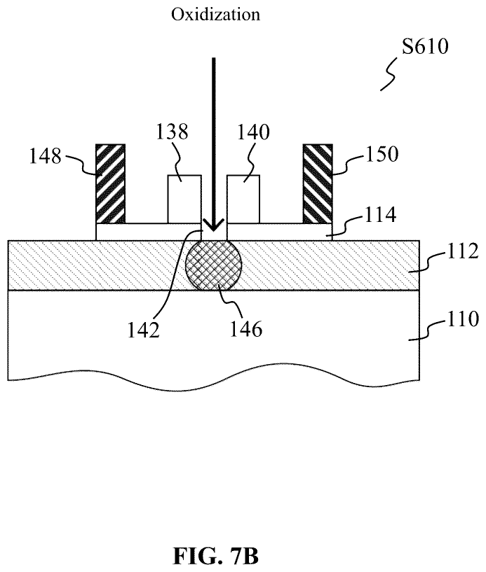

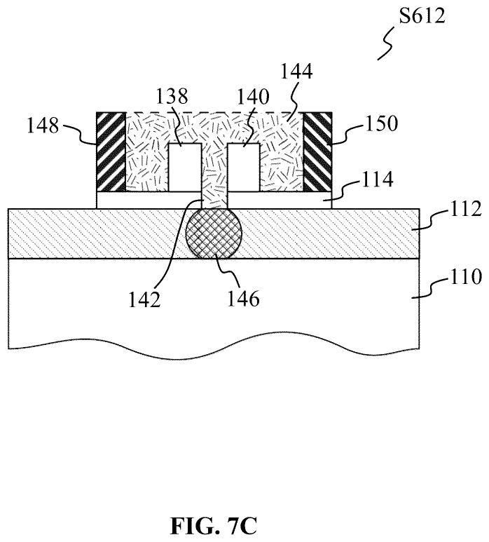

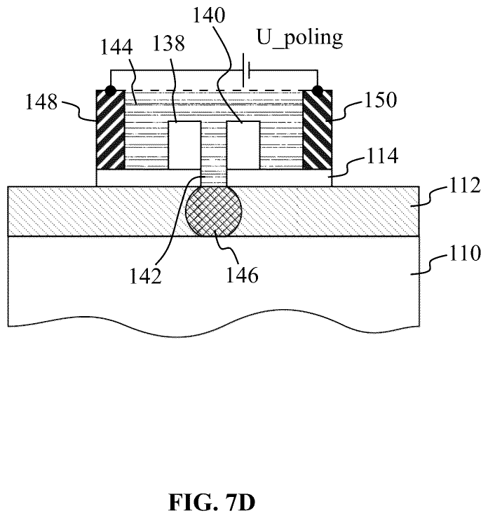

FIGS. 7A-7D schematically illustrate how the modulation structure 106 of the PIC 100 may be manufactured in accordance with the method 600. FIG. 7A refers to the steps S606 and S608, in which the conventional etching and/or lithography techniques are used to access the SC layer 116 and form the rails 138 and 140 therein. FIG. 7B refers again to the step S608, in which the SC layer 112 is subjected to oxidization in the region 146. Optionally, the electrodes 148 and 150 may be also formed in the step S608. FIG. 7C refers to the step S610, in which the organic electro-optic material 144 is deposited so as to cover the slot 142. FIG. 7D refers to the additional steps, in which the organic electro-optic material 144 is subjected to the poling voltage after it is heated to the glass transition point.

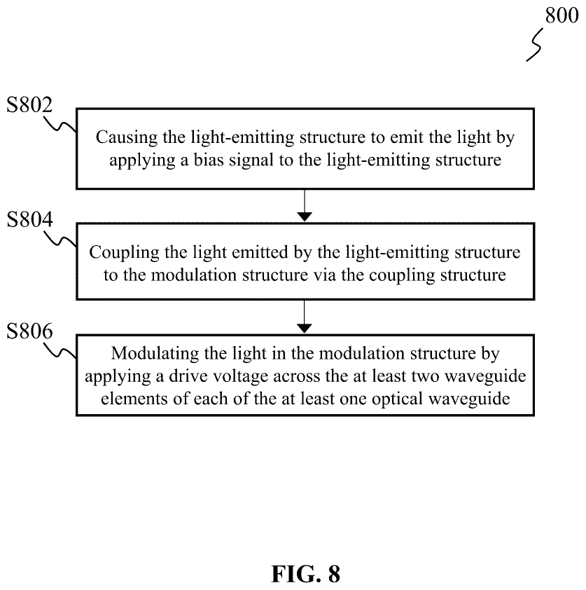

FIG. 8 shows a flowchart of a method 800 for operating the PIC 100 according to one exemplary embodiment. The method 800 starts with a step S802, in which the light-emitting structure 102 is caused to emit the light by applying a bias signal thereto. Then, the method 800 proceeds to a step S804, in which the light emitted by the light-emitting structure 102 is coupled to the modulation structure 106 via the coupling structure 104. After that, the method 800 goes on to a step S806, in which the light is subjected to electro-optic modulation in the modulation structure 106 by applying a drive voltage across the waveguide elements, i.e., the rails 138 and 140. The drive voltage may be an on-off keying (OOK) signal, such as a non-return-to-zero (NRZ) OOK signal. The NRZ-OOK signal should have a certain amplitude in Volts (peak-to-peak voltage) and a certain frequency correlated to a data transfer speed to be achieved (e.g., a frequency ranging from 100 to 200 GHz). The pulses of the NRZ-OOK signal may have, for instance, a rectangular shape. Alternatively, the drive voltage may be a PAM4 signal or a PAM8 signal. Furthermore, the drive voltage may in the form of multiple signals, e.g., for coherent communications (QPSK, 16 QAM, 32 QAM 64 QAM, etc.).

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A Photonic Integrated Circuit (PIC), comprising:
a light-emitting structure configured to emit light;
a modulation structure configured to modulate the light; and
a coupling structure configured to: (i) couple the light emitted by the light-emitting structure to the modulation structure, and (ii) electrically isolate the light-emitting structure from the modulation structure;
wherein the light-emitting structure, the modulation structure and the coupling structure comprise at least one common underlying non-conductive layer and at least two common semiconductor (SC) layers provided on the at least one common underlying non-conductive layer; and
wherein the modulation structure comprises at least one optical waveguide each at least partly implemented in the at least two common SC layers, each of the at least one optical waveguide comprising a waveguide cladding and a waveguide core embedded in the waveguide cladding, the waveguide core comprising at least two waveguide elements spaced apart from each other by an electro-optic material, the electro-optic material having a variable refractive index and being part of the waveguide cladding, the at least two waveguide elements being configured to provide electro-optic modulation of the light in response to a drive voltage applied across the at least two waveguide elements.

2. The PIC of claim 1, wherein the electro-optic material is an organic or inorganic material.

3. The PIC of claim 1, wherein each of the at least one optical waveguide is implemented as one of a slot waveguide, a sub-wavelength grating structure and a photonic-crystal waveguide.

4. The PIC of claim 1, wherein the at least two common SC layers comprise a first SC layer provided on the at least one common underlying non-conductive layer and at least two second SC layers provided on the first SC layer, and wherein the first SC layer is part of the waveguide cladding and the at least two waveguide elements are implemented in the at least two second SC layers, the first SC layer being oxidized under the at least two waveguide elements so as to provide electrical isolation of the at least two waveguide elements from each other.

5. The PIC of claim 1, wherein the light-emitting structure is implemented as a single-mode laser.

6. The PIC of claim 5, wherein the single-mode laser comprises a Fabry-Perot (FP) cavity or a Distributed Feedback (DFB) cavity.

7. The PIC of claim 5, wherein the single-mode laser comprises a Distributed Bragg reflector.

8. The PIC of claim 1, wherein the light-emitting structure comprises:
a bottom cladding layer having a first electrical conductivity;
a core layer provided on the bottom cladding layer and made of a light-emitting SC material; and
a top cladding layer provided on the core layer and having a second electrical conductivity, the second electrical conductivity being opposite to the first electrical conductivity;
wherein the core layer has a refractive index higher than a refractive index of each of the bottom cladding layer and the top cladding layer; and
wherein the bottom cladding layer is provided on the at least two common SC layers.

9. The PIC of claim 8, wherein the core layer comprises at least one of:
a sub-layer of quantum dots;
a sub-layer of quantum wells;
a sub-layer of quantum dashes; and
a sub-layer of quantum wires.

10. The PIC of claim 9, wherein the sub-layer of quantum dots comprises (In,Ga)As quantum dots, or the sub-layer of quantum dots comprises InAs quantum dots embedded into a sub-layer of InGaAs quantum wells.

11. The PIC of claim 3, wherein each of the at least one optical waveguide is implemented as the slot waveguide and the at least two waveguide elements are configured as two conductive rails of the slot waveguide, and wherein the slot waveguide has an inter-rail spacing of less than 500 nm.

12. The PIC of claim 11, wherein the inter-rail spacing is less than 200 nm.

13. The PIC of claim 1, wherein the electro-optic material has an electro-optic coefficient r33 of more than 50 pm/V.

14. The PIC of claim 1, wherein the coupling structure is shaped to taper towards the modulation structure.

15. The PIC of claim 14, wherein the coupling structure is shaped to taper faster first and then slower towards the modulation structure.

16. The PIC of claim 1, wherein the coupling structure comprises at least one of a grating and an evanescent coupling element.

17. The PIC of claim 1, further comprising an inert encapsulation layer covering the electro-optic material.

18. A method for manufacturing the PIC according to claim 1, the method comprising:
providing the at least one common underlying non-conductive layer;
epitaxially growing a stack of SC layers on the at least one common underlying non-conductive layer, the stack of SC layers comprising the at least two common SC layers;
treating the stack of SC layers within the modulation structure so as to access the at least two common SC layers;
forming each of the at least one optical waveguide at least partly in the at least two common SC layers such that the at least two waveguide elements of the waveguide core are spaced apart from each other; and
depositing the electro-optic material on and between the at least two waveguide elements.

19. The method of claim 18, further comprising, after said depositing, applying a poling voltage to the electro-optic material.

20. A method for operating the PIC according to claim 1, the method comprising:
causing the light-emitting structure to emit the light by applying a bias signal to the light-emitting structure;
coupling the light emitted by the light-emitting structure to the modulation structure via the coupling structure; and
modulating the light in the modulation structure by applying a drive voltage across the at least two waveguide elements of each of the at least one optical waveguide.
